(19) United States
(12) Patent Application Publication
(10) Pub. No.: US 2011/0185126 A1
(43) Pub. Date: Jul. 28, 2011

(54) MULTIPROCESSOR SYSTEM

(75) Inventors: Tsuneki SASAKI, Kanagawa (JP); Shuichi KUNIE, Kanagawa (JP); Tatsuya KAWASAKI, Kanagawa (JP)

(73) Assignee: RENESAS ELECTRONICS CORPORATION, Kanagawa (JP)

(21) Appl. No.: 13/012,562

(22) Filed: Jan. 24, 2011

(30) Foreign Application Priority Data
Jan. 25, 2010 (JP) 2010-013373

(51) Int. Cl. G06F 12/08

(52) U.S. Cl. 711/124; 711/130; 711/E12.026; 711/E12.038

(57) ABSTRACT

When a processor has transitioned to an operation stop state, it is possible to reduce the power consumption of a cache memory while maintaining the consistency of cache data. A multiprocessor system includes first and second processors, a shared memory, first and second cache memories, a consistency management circuit for managing consistency of data stored in the first and second cache memories, a request signal line for transmitting a request signal for a data update request from the consistency management circuit to the first and second cache memories, an information signal line for transmitting an information signal for informing completion of the data update from the first and second cache memories to the consistency management circuit, and a cache power control circuit for controlling supply of a clock signal and power to the first and second cache memories in accordance with the request signal and the information signal.

### CROSS-REFERENCE TO RELATED APPLICATIONS

The disclosure of Japanese Patent Application No. 2010-13373 filed on Jan. 25, 2010 including the specification, drawings and abstract is incorporated herein by reference in its entirety.

### BACKGROUND

1. Field of the Invention

The present invention relates to a multiprocessor system in which multiple processors share memory space and operate in parallel.

2. Description of Related Art

In a multiprocessor system in which multiple processors share memory space and operate in parallel, there is a growing need for power saving control techniques for application to mobile devices etc. Further, in the multiprocessor system, each processor may have a respective cache memory to compensate for the difference between the speed of access to a memory shared by each processor and the processing speed of each processor.

In this case, when a processor accesses the shared memory, data (cache data) stored in the corresponding cache memory is updated. Accordingly, it is necessary to maintain the consistency of data among the cache and shared memories so that each processor can access the latest correct data at all times. This is called cache coherence or cache coherency.

FIG. 8 is a diagram showing an example of an SMP multiprocessor system in which multiple processors share memory space and operate in parallel. The multiprocessor system shown in FIG. 8 includes a processor 1 having a processor core 2 and its corresponding cache memory 3, a processor 11 having a processor core 12 and its corresponding cache memory 13, a shared memory 5 shared by the two processors, and a mutual coupling network 4 for coupling the two processors 1 and 11 and the shared memory 5. The two processors 1 and 11 and the shared memory 5 can transfer data mutually via the mutual coupling network 4. The mutual coupling network 4 is configured of single bus, multibus, or multistage mutual coupling network, in accordance with system requirements.

Referring to FIG. 8, an example of cache coherence control for maintaining the consistency of cache data stored in the cache memories will be described. Although various protocols for managing cache coherence (cache coherence protocols) have been proposed, only a basic concept will be described.

In FIG. 8, the two processors 1 and 11 write data, with the write-through method, to the respective cache memories and the shared memory. Further, in an initial state, the two cache memories 3 and 13 store the same data X.

When the processor core 2 updates data X to data Y, data X in the cache memory 3 and the shared memory 5 is updated to data Y. In this case, if data X in the cache memory 13 remains not updated to data Y, there is a mismatch in cache data between the cache memories 3 and 13.

To solve the above problem, for example, the cache memories 3 and 13 monitor all writing in the mutual coupling network 4. In this case, the cache memories 3 and 13 can recognize the update of data X stored in the cache memories 3 and 13.

When the cache memory 13 recognizes that data X in the shared memory 5 has been updated to data Y, the cache memory 13 sets data X stored in the cache memory 13 to “Invalid”. Since the pre-update data X in the cache memory 13 is set to “Invalid”, the processor core 12 corresponding to the cache memory 13 cannot read the data, and consequently reads the post-update data Y from the shared memory 5. At this time, the cache memory 13 stores data Y as cache data, thus avoiding the mismatch in cache data between the cache memories.

Further, a multiprocessor system that can maintain cache coherence and implement power saving is disclosed in Japanese Unexamined Patent Publication No. 2005-25726. The system described in Japanese Unexamined Patent Publication No. 2005-25726 and shown in FIG. 9 includes multiple processor cores 22, respective cache memories 23 coupled to the processor cores, and a memory access control device 24 for performing control so as to maintain the sameness of cache data stored in the cache memories 23.

In this configuration, e.g. when there is no instruction to be processed by a processor core 22, clock supply to the processor core 22 is stopped for power saving. That is, the processor core 22 can transition to an inactive state in which the clock is not supplied (but power is supplied). Even when the processor 22 core is in the inactive state, the corresponding cache memory 23 remains in an active state in which the clock and power are supplied, and therefore can perform processing for maintaining the consistency of cache data.

Therefore, when the processor core 22 has transitioned to the inactive state, the power consumption of the processor core 22 can be reduced, while the cache memory 23 operates as normal and maintains the consistency of the caches.

### SUMMARY

In the multiprocessor system disclosed in Japanese Unexamined Patent Publication No. 2005-25726, even when the clock supply to the processor core 22 is stopped so that the processor 22 core is in the inactive state, the clock and power supply to the cache memory 23 is maintained. Therefore, although the cache memory 23 can continue the cache coherence operation for maintaining the consistency of cache data, the clock signal and power are continuously supplied to the cache memory 23, which does not lead to sufficient power saving.

According to an aspect of the present invention, a multiprocessor system includes:

a first processor having a first cache memory;

a second processor having a second cache memory;

a consistency management circuit coupled to the first and the second cache memories to manage consistency of data stored in the first and the second cache memories; and

a cache power control circuit configured to control power supply to the first or the second cache memory in response to a control signal output from the consistency management circuit.

When the processor has transitioned to an operation stop state, the cache power control circuit controls the supply of the clock signal and power to the corresponding cache memory in accordance with the request signal and the information signal.

According to the present invention, when the processor has transitioned to the operation stop state, it is possible to perform the operation for maintaining the consistency of cache data and reduce the power consumption of the cache memory.

### BRIEF DESCRIPTION OF THE DRAWINGS

FIG. 1 is a block diagram showing the configuration of a multiprocessor system according to a first embodiment;

FIG. 2 is a diagram showing an example of the configuration of cache lines;

FIG. 3 is a circuit diagram showing an example of the power supply configuration of a cache memory according to the first embodiment;

FIG. 4 is a block diagram of assistance in explaining cache coherence according to the first embodiment;

FIG. 5 is a timing chart of assistance in explaining the operation of a cache power control circuit according to the first embodiment;

FIG. 6 is a timing chart of assistance in explaining the operation of the cache power control circuit in consistency management operation according to the first embodiment;

FIG. 7 is a circuit diagram showing an example of the power supply configuration of a cache memory according to a second embodiment;

FIG. 8 is a block diagram showing the configuration of a general multiprocessor system; and

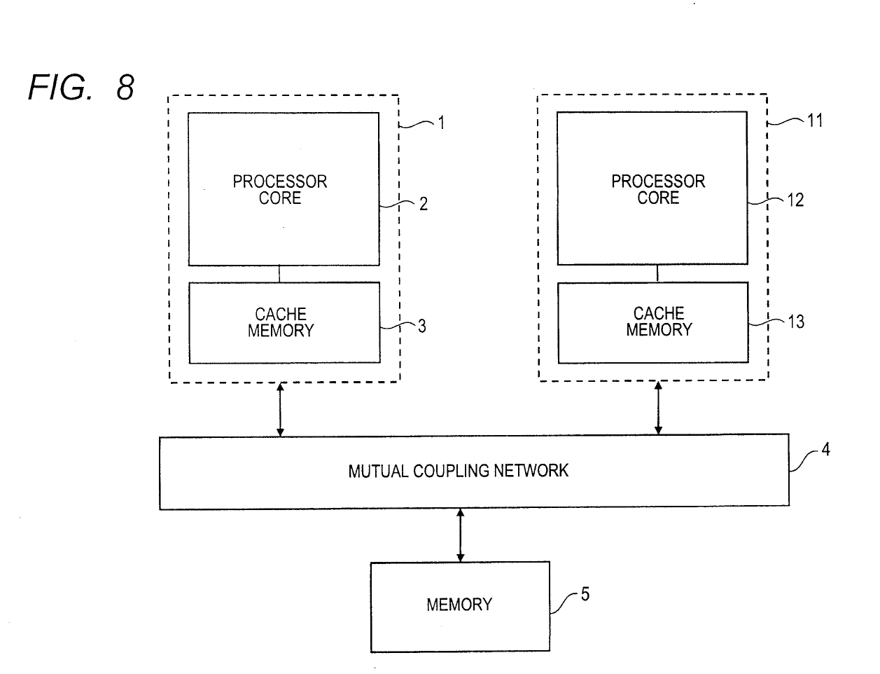

FIG. 9 is a block diagram showing the configuration of a multiprocessor system according to Japanese Unexamined Patent Publication No. 2005-25726.

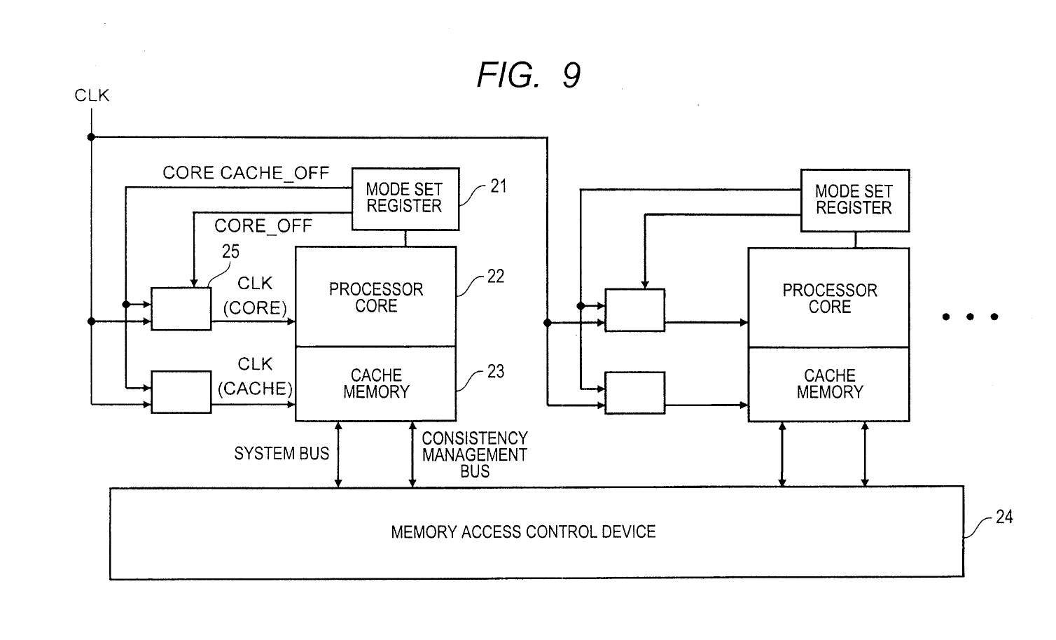

### DETAILED DESCRIPTION OF THE PREFERRED EMBODIMENTS

Hereinafter, specific embodiments of the present invention will be described in detail with reference to the accompanying drawings. Note that the present invention is not limited to embodiments described below. To clarify the explanation, the following description and drawings are simplified as appropriate.

### First Embodiment

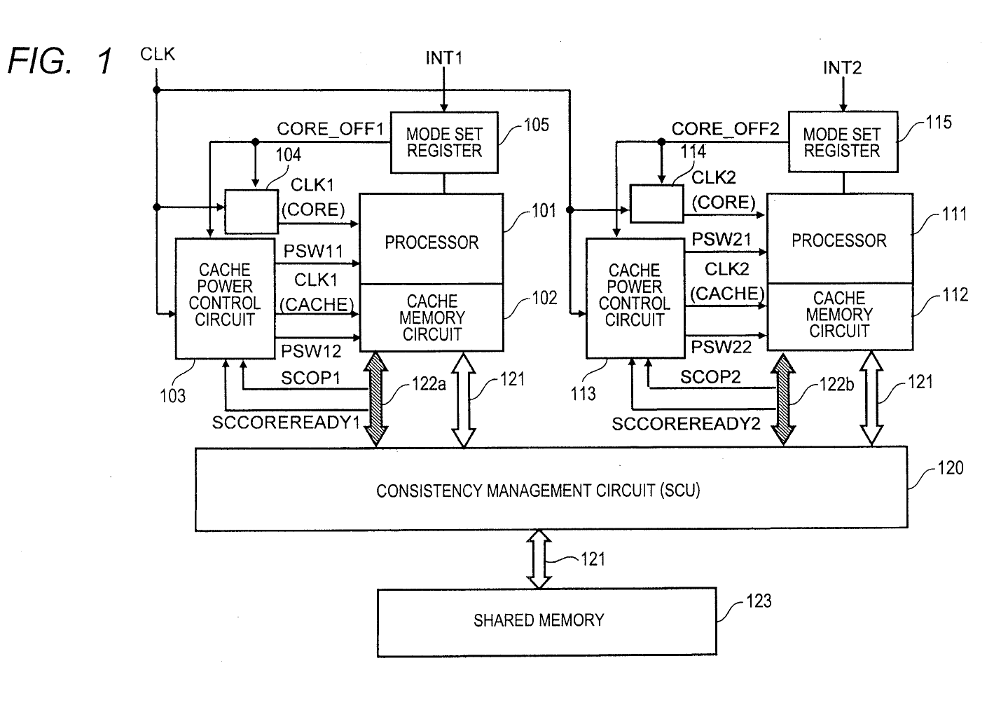

Hereinafter, embodiments of the present invention will be described with reference to the drawings. FIG. 1 is a block diagram showing the configuration of a multiprocessor system according to a first embodiment of the present invention. Although the number of processors is two in FIG. 1, it may be three or more.

The multiprocessor system shown in FIG. 1 includes two processors 101 and 111, cache memories 102 and 112 provided respectively corresponding to the processors 101 and 111, a consistency management circuit 120, cache power control circuits 103 and 113, and consistency management buses 122a and 122b. Further, a shared memory 123, mode set registers 105 and 115, clock control circuits 104 and 114, and a system bus 121 are peripheral circuits in the multiprocessor system according to this embodiment.

The processors 101 and 111 have a power saving function of transitioning to an operation stop state of stopping the supply of the clock signal and power in order to reduce power consumption, e.g. when there is no instruction to be processed. Further, the multiprocessor system may have another processor that does not have the power saving function.

If the processor 101 transitions to the operation stop state, the processor 101 sets a value indicating the operation stop state to the mode set register 105. The mode set register 105 outputs a mode signal CORE_OFF1 (H level in this case) corresponding to the set value. Based on the mode signal CORE_OFF1 of the H level from the mode set register 105, the clock control circuit 104 stops the supply of a clock signal CLK1 (CORE) to the processor 101. In response to the clock supply stop, the processor 101 stops operation and transitions to the operation stop state. Further, to suppress the leakage current of the processor 101, the cache power control circuit 103 may power off the processor 101 by a power supply control signal PSW11 for controlling power supply to the processor 101 based on the mode signal CORE_OFF1 of the H level. In this case, it is desirable to power off the processor 101 in a state of retaining an internal register state by using a retention flip-flop (not shown) or the like.

Similarly, if the processor 111 transitions to the operation stop state, the processor 101 sets a value indicating the operation stop state to the mode set register 105. The mode set register 115 outputs a mode signal CORE_OFF2 (H level in this case) corresponding to the set value. Based on the mode signal CORE_OFF2 of the H level from the mode set register 115, the clock control circuit 104 stops the supply of a clock signal CLK2 (CORE) to the processor 111. In response to the clock supply stop, the processor 111 stops operation and transitions to the operation stop state. Further, to suppress the leakage current of the processor 111, the cache power control circuit 113 may power off the processor 111 by a power supply control signal PSW21 for controlling power supply to the processor 111 based on the mode signal CORE_OFF2 of the H level. In this case, it is desirable to power off the processor 111 in a state of retaining an internal register state by using a retention flip-flop (not shown) or the like.

The cache memory 102 is a storage device that can read and write data faster than the shared memory 123. When the processor 101 reads and writes data from and to the shared memory 123, the cache memory 102 temporarily stores the data. When the processor 101 reads data in the shared memory 123, the processor 101 confirms whether there is corresponding valid cache data in the cache memory 102. If there is valid cache data, the processor 101 reads the data from the high-speed cache memory 102 instead of the low-speed shared memory 123, thereby enhancing the speed of the system. The cache memory 112 has the same configuration as the cache memory 102.

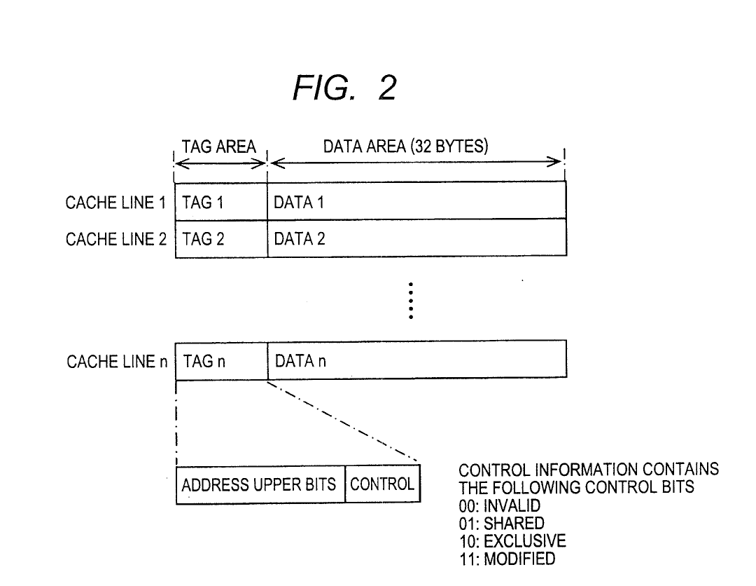

The cache memory 102 manages cache data in predetermined units called cache lines. Each cache line has a data area and a tag area. FIG. 2 is a diagram showing an example of the configuration of cache lines in the case of a data area size of 32 bytes and fully associative mapping. The data area stores cache data which is a copy of data in the shared memory 123. The tag area stores part of address information indicative of the storage position of the cache data in the shared memory 123 and control information containing state bits indicative of the state of the cache line.

Since the cache data is managed in the cache line size, it is not necessary to store all the bits of the address information into the tag area. In the example of FIG. 2, the cache line size is 32 bytes, and the upper bits of the address excluding the lower 5 bits are stored in the tag area. For example, if the address bus is 32 bits wide, the upper 27 bits of the address are stored. The above configuration of the cache line is merely an example and may be changed.

The state bits stored in the tag area indicate the state of the corresponding cache line. Although various cache coherence protocols have been proposed, the MESI protocol will be described by way of example. Since there are four states in the MESI protocol, at least two bits are required for the state bits.

In the MESI protocol, the cache line assumes any one of the following four states as shown in FIG. 2. A first state (“Modified”) indicates a state (dirty) in which the latest data exists only in the corresponding cache line and has been changed from a value in the shared memory 123. A second state (“Exclusive”) indicates a state (clean) in which the latest data exists only in the corresponding cache line and matches a value in the shared memory 123. A third state (“Shared”) indicates a state in which the same data exists in the other cache memory in the system and matches a value in the shared memory 123. A fourth state (“Invalid”) indicates a state in which the data in the corresponding cache line is invalid.

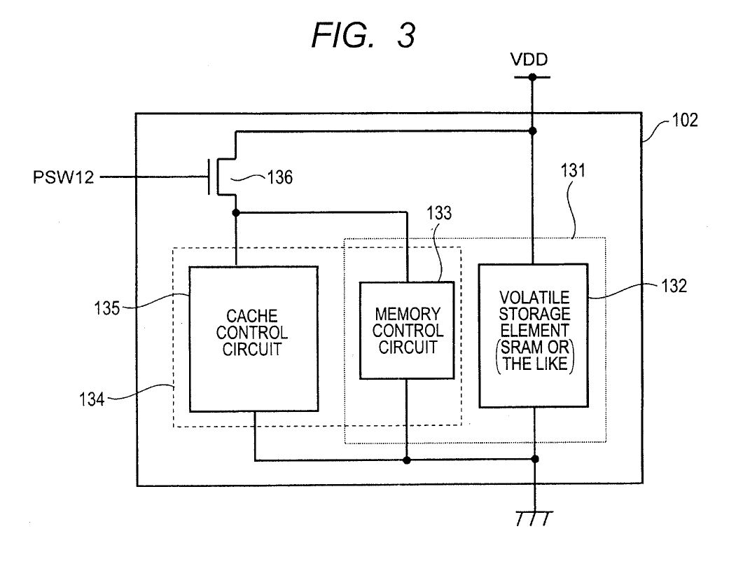

FIG. 3 shows an example of the power supply configuration of the cache memory 102 according to this embodiment. The cache memory 102 includes a volatile memory 131 (e.g., SRAM) and a cache control circuit 135 for controlling the operation of the cache memory. Further, the volatile memory 131 includes a volatile storage element 132 for storing and retaining written data and a memory control circuit 133 for controlling (address decoding etc.) the volatile storage element. The memory control circuit 133 and the cache control circuit 135 are coupled in parallel to configure a cache memory control circuit 134. A power supply switch 136 which is controlled by a power supply control signal PSW12 is provided in the power supply line of the cache memory control circuit 134. The cache memory 102 can switch between a normal state of operating as a normal cache memory and a power saving state of only storage and retention, in accordance with the signal level of the power supply control signal PSW12 outputted from the cache power control circuit 103 described later.

Referring back to FIG. 1, the cache power control circuit 103 controls whether to supply the clock signal and power to the cache memory 102 and supply power to the processor 101. The cache power control circuit 103 monitors the mode signal CORE_OFF1. When the cache power control circuit 103 determines that the clock input to the processor 101 is stopped and the processor 101 has transitioned to the operation stop state, the cache power control circuit 103 stops the supply of a clock signal CLK1 (CACHE) to the corresponding cache memory 102. Further, the cache power control circuit 103 stops power supply to the cache memory 102 by the power supply control signal PSW12 for controlling power supply to the cache memory 102. Furthermore, as described above, the cache power control circuit 103 may stop power supply to the processor 101 by the power supply control signal PSW11 for controlling power supply to the processor 101.

Similarly, the cache power control circuit 113 controls whether to supply the clock signal and power to the cache memory 112 and supply power to the processor 111. The cache power control circuit 113 monitors the mode signal CORE_OFF2. When the cache power control circuit 113 determines that the clock input to the processor 111 is stopped and the processor 111 has transitioned to the operation stop state, the cache power control circuit 113 stops the supply of a clock signal CLK2 (CACHE) to the corresponding cache memory 112. Further, the cache power control circuit 113 stops power supply to the cache memory 112 by the power supply control signal PSW22 for controlling power supply to the cache memory 112. Furthermore, as described above, the cache power control circuit 113 may stop power supply to the processor 111 by the power supply control signal PSW21 for controlling power supply to the processor 111.

Further, when the processor 101 is in the operation stop state and the corresponding cache memory 102 is in the power saving state of stopping the clock and power supply, the cache power control circuit 103 monitors a SCOP bus signal and a SCCOREREADY signal. Further, the cache power control circuit 103 controls the supply and stop of the clock and power to the cache memory 102, in accordance with the states of the SCOP bus signal and the SCCOREREADY signal. The details of the SCOP bus signal and the SCCOREREADY signal will be described later.

Similarly, when the processor 111 is in the operation stop state and the corresponding cache memory 112 is in the power saving state of stopping the clock and power supply, the cache power control circuit 113 monitors a SCOP bus signal and a SCCOREREADY signal. Further, the cache power control circuit 113 controls the supply and stop of the clock and power to the cache memory 112, in accordance with the states of the SCOP bus signal and the SCCOREREADY signal.

Next, the clock control circuit 104 controls clock supply to the processor 101 by setting the mode signal CORE_OFF1. For example, when the mode signal CORE_OFF1 is at an L level, the clock control circuit 104 supplies the input clock signal CLK1 (CORE) to the processor 101. When the mode signal CORE_OFF1 is at the H level, the clock control circuit 104 stops the supply of the clock signal CLK1 (CORE) to the processor 101.

The mode set register 105 is a register for setting the operation mode of the processor, and outputs the mode signal CORE_OFF1 of the H level or the L level in accordance with a set value. Further, the mode set register 105 can be controlled not only from the coupled processor 101 but also by an external signal INT1 in a hardware manner, and outputs the mode signal CORE_OFF1 of the H level or the L level by the control.

Further, the clock control circuit 114 and the mode set register 115 of the processor 111 has the same configuration as the clock control circuit 104 and the mode set register 105 of the processor 101.

Next, the consistency management circuit 120 is a circuit for performing control so as to maintain the consistency of cache data stored in the cache memories 102 and 112. The consistency management circuit 120 is coupled to the cache memories 102 and 112 and the shared memory 123 via the system bus 121, and coupled to the processors 101 and 111 via the cache memories 102 and 112. Further, the consistency management circuit 120 is coupled to the cache memories 102 and 112 via the consistency management buses 122a and 122b, provided separately from the system bus 121, for transferring a control signal and data necessary to maintain the sameness of cache data stored in the cache memories 102 and 112.

The consistency management circuit 120 has tag memories (not shown) storing the same information as the tag areas of the cache lines stored in the cache memories 102 and 112 subject to the control of the consistency of cache data. Therefore, the consistency management circuit 120 can confirm the states of the cache lines in the cache memories 102 and 112 by referring to the tag memories.

The consistency management circuit 120 monitors the system bus 121 and the consistency management buses 122a and 122b, and also refers to its own tag memories. If the consistency management circuit 120 determines that it is necessary to control the consistency of cache data in the cache memories 102 and 112, the consistency management circuit 120 issues a consistency command via the consistency management buses 122a and 122b.

Japanese Unexamined Patent Publication No. 2005-25726 defines the following four consistency commands. A first one is a FORCE command for requesting a cache line state change. A second one is a CLEAN command for requesting a cache line state change and cleaning. A third one is a COPY command for requesting a cache line state change and a copy. A fourth one is a NOP command indicating no operation. Here, description will be made in accordance with the above definition.

The consistency management buses 122a and 122b are signal lines necessary for the transfer of the above-described consistency commands, and are provided for the respective cache memories. Further, the consistency management buses 122a and 122b have SCOP (SCOP1, SCOP2) buses (request signal lines) through which the consistency management circuit 120 informs a required consistency command (request signal for a data update request) to the cache memories 102 and 112. Further, the consistency management buses 122a and 122b have buses (information signal lines) for SCCOREREADY signals (SCCOREREADY1, SCCOREREADY2) through which the cache memories 102 and 112 inform the consistency management circuit 120 that the cache memories 102 and 112 are ready to process a consistency command and processing by a consistency command has been completed.

The SCOP1 bus and the SCOP2 bus are 2-bit signal lines for informing the start of a consistency command from the consistency management circuit 120 to the cache memories 102 and 112. In accordance with signal values, for example, “00” denotes the NOP command, “01” denotes the FORCE command, “10” denotes the COPY command, and “11” denotes the CLEAN command.

In this case, the cache power control circuits 103 and 113 monitor the 2-bit signal lines of the respective SCOP buses and can thereby determine that a consistency command has been issued from the consistency management circuit 120 to the cache memories 102 and 112 when any one of the signal lines becomes the H level.

The SCCOREREADY signals inform a cache state from the cache memories 102 and 112 to the consistency management circuit 120. For example, the L level informs that the caches are ready for operation for consistency, and the H level informs that operation for the consistency of the caches has been completed.

In the case where the consistency management circuit 120 has informed the start of a consistency command, e.g., to the cache memory 102 via the SCOP bus, the consistency management circuit 120 transmits data necessary for processing after the SCCOREREADY1 signal from the cache memory 102 is set to the L level; therefore, it is possible to prevent incorrect transmission to the cache memory 102 that is in the process of returning from the power saving state and not yet ready for the operation.

The shared memory 123 is a memory circuit at least part of which is shared between the processors 101 and 111. The configuration thereof may be a combination of a plurality of blocks, a single block, a configuration including a level 2 cache, or the like, depending on system requirements.

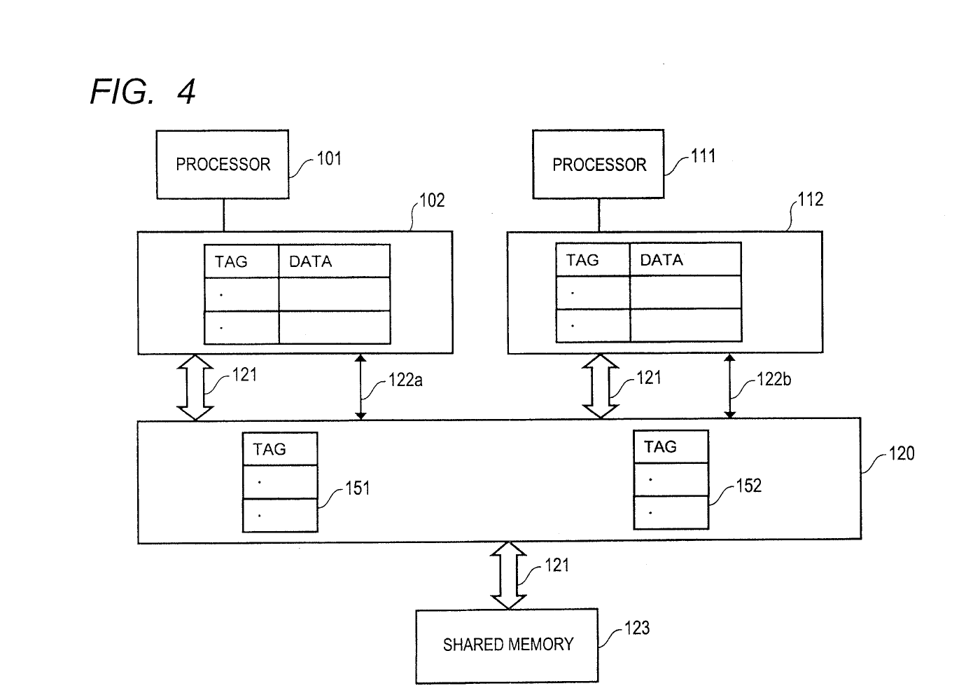

Next, operations related to the consistency management circuit 120 will be described with reference to FIG. 4. Assume that the processor 101 is in the operation stop state, the cache memory 102 is in the power saving state of stopping the clock and power supply, and the processor 111 and the cache memory 112 are supplied with the clock and power as normal and perform processing.

The consistency management circuit 120 has a tag memory 151 storing the same information as the tag areas of the cache memory 102 and a tag memory 152 storing the same information as the tag areas of the cache memory 112.

At this time, the processor 101 is in the operation stop state, and therefore does not make requests such as reading and writing from/to the shared memory 123. Accordingly, the consistency management circuit 120 monitors signals on the system bus 121 and the consistency management buses 122a and 122b, and performs operation according to memory access by the processor 111.

Hereinafter, description will be made of operations in the case where, in this state, consistency commands are issued from the consistency management circuit 120 to the cache memory 102 that is in the power saving state. Referring to FIG. 4, if the processor 111 reads data in the shared memory 123, the processor 111 makes a read request to a predetermined address in the shared memory 123 via the cache memory 112 and the system bus 121.

The consistency management circuit 120 monitors the system bus 121. When the consistency management circuit 120 detects the read request from the processor 111, the consistency management circuit 120 refers to the read destination address and to the address upper bit information and the state bits in its own tag memories 151 and 152, and confirms whether there is data of the read request in the tag memory 151 or 152 and the cache line state.

If the address of the read request by the processor 111 exists in the tag memory 151 and the state is “Exclusive”, it indicates that the latest data exists in the cache memory 102 and the shared memory 123 but does not exist in the cache memory 112.

Since the valid cache data does not exist in the cache memory 112, the processor 111 reads the data of the corresponding address from the shared memory 123, and the cache memory 112 stores a copy of the read data into the cache line.

At this time, the latest data of the read address exists in the shared memory 123, the cache memory 102, and also the cache memory 112, the state bits of the cache lines in the cache memories 102 and 112 and the tag memories 151 and 152 need to be set to “Shared”.

At this time, the consistency management circuit 120 issues the FORCE command which is one of the consistency commands to the cache memory 102 in the power saving state to request a change of the cache line state in the cache memory 102 from “Exclusive” to “Shared”.

In response to the FORCE command, the cache memory 102 updates the state bits of the corresponding cache line to “Shared”.

If the data of the read request, by the processor 111, to the predetermined address in the shared memory 123 exists in the state of “Modified” in the tag memory 151, it indicates that the latest data exists in the cache memory 102 but does not exist in the shared memory 123 nor in the cache memory 112.

At this time, the consistency management circuit 120 issues the CLEAN command to the cache memory 102 which corresponds to the tag memory 151 and is in the power saving state to reflect the data of the cache line containing the corresponding address into the shared memory 123. In response to the CLEAN command, the cache memory 102 writes the data of the corresponding cache line into the shared memory 123.

Then, the processor 111 reads the data of the corresponding address from the shared memory 123, and the cache memory 112 stores a copy of the read data into the cache line. At this time, the cache lines in the cache memories 102 and 112 and the tag memories 151 and 152 share the latest data.

At this time, again the consistency management circuit 120 issues the FORCE command which is one of the consistency commands to the cache memory 102 in the power saving state to request a change of the cache line state in the cache memory 102 from “Exclusive” to “Shared”. In response to the FORCE command, the cache memory 102 updates the state bits of the corresponding cache line to “Shared”.

On the other hand, if the processor 111 writes data in the shared memory 123, the processor 111 makes a write request to a predetermined address in the shared memory 123 via the system bus 121. The consistency management circuit 120 monitors the system bus 121. When the consistency management circuit 120 detects the write request from the processor 111, the consistency management circuit 120 refers to the write destination address and to the address upper bit information and the state bits in its own tag memories 151 and 152, and confirms whether there is data of the write request in the tag memory 151 or 152 and the cache line state.

If the data of the address of the write request by the processor 111 exists in the tag memory 151 and the state is “Shared”, it indicates that the cache memories 102 and 112 and the shared memory 123 share the data.

After the data of the predetermined address of the write request by the processor 111 is written to the shared memory 123 and the cache memory 112, the data in the cache memory 102 corresponding to the tag memory 151 becomes a mismatch. Therefore, the consistency management circuit 120 issues the FORCE command which is one of the consistency commands to the cache memory 102 in the power saving state to request a change of the cache line state in the cache memory 102 to “Invalid”. In response to the FORCE command, the cache memory 102 updates the state bits of the corresponding cache line to “Invalid”.

While the description has been made of the example in which the consistency management circuit 120 issues the consistency commands to the cache memory 102 in the power saving state in accordance with the processor 101 in the operation stop state, the above control procedure is merely an example, and any other control procedure may be used to avoid the cache data mismatch.

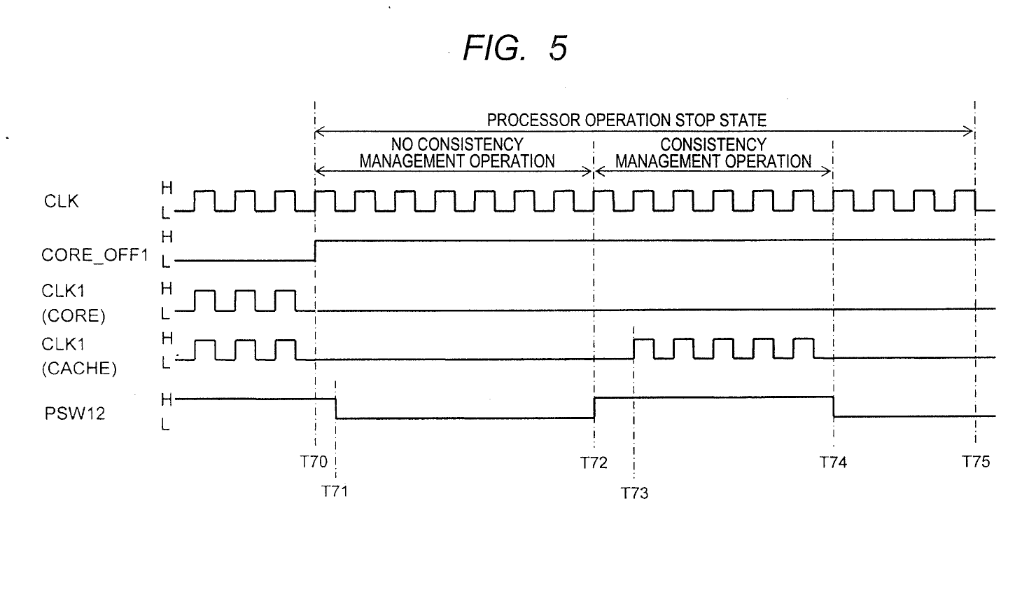

Next, the operation of the cache power control circuit 103 will be described with reference to FIGS. 1, 2, and 5. FIG. 5 is a diagram of assistance in explaining the operations of the clock signals and the power supply in the power saving operation. Since FIG. 5 is a schematic timing chart of assistance in explaining the clock and power supply operations, clock waveforms shown in FIG. 5 do not indicate the clock cycle necessary for each operation.

First, description will be made of a normal operation state (before T70) in which the processor 101 performs requested processing. The clock signal CLK1 (CORE) is supplied to the processor 101, and the clock signal CLK1 (CACHE) is supplied to the cache memory 102. Further, the power supply control signal PSW12 for controlling power supply to the cache memory 102 is set to the H level, so that power is supplied to the cache memory 102.

Next, description will be made of the case where the processor 101 enters the operation stop state at T70 in FIG. 5, for example, due to no instruction to be executed. The processor 101 sets the mode set register 105 shown in FIG. 1 so that the mode signal CORE_OFF1 becomes the H level. The mode signal CORE_OFF1 of the H level stops the clock signal CLK1 (CORE) to the processor 101.

In the configuration shown in FIG. 1, the mode signal CORE_OFF1 is also inputted to the cache power control circuit 103. When the mode signal CORE_OFF1 is at the H level, the cache power control circuit 103 stops the supply of the clock signal CLK1 (CACHE) to the cache memory 102 (T70). Then, the cache power control circuit 103 sets the power supply control signal PSW12 for controlling power supply to the cache memory 102 to the L level (T71). When the power supply control signal PSW12 is set to the L level, the power supply switch 136 (see FIG. 3) in the cache memory 102 is turned off, which stops power supply to the cache memory control circuit 134.

Therefore, in this embodiment, the transition of the processor 101 to the operation stop state stops the clock signal CLK1 (CACHE) and power supply to the cache memory 102. This can reduce the power consumption of the cache memory 102.

Further, referring to FIG. 5, description will be made of operations in the case where a consistency command is issued to the cache memory 102 in the power saving state. When the consistency management circuit 120 issues a consistency command (COPY, CLEAN, or FORCE) to the cache memory 102 at time T72, one of the signal lines of the SCOP bus becomes the H level. The cache power control circuit 103 monitors the signal lines of the SCOP bus and, upon detecting the H level, sets the power supply control signal PSW12 to the H level, which resumes power supply to the cache memory 102 in the power saving state. Then, the cache power control circuit 103 resumes the supply of the clock signal CLK1 (CACHE) to the cache memory 102 (T73), which therefore becomes enabled.

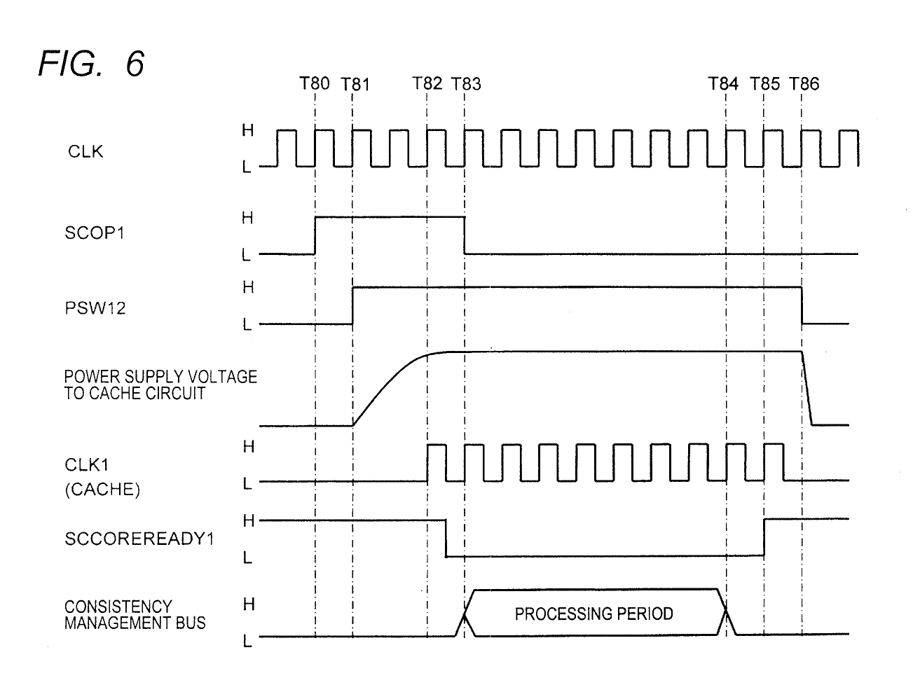

Referring now to FIG. 6, the operation of the cache power control circuit 103 will be described in more detail. Since FIG. 6 is a schematic timing chart of assistance in explaining each operation, clock waveforms shown in FIG. 6 do not indicate the clock cycle necessary for each operation.

As described above, after transition to the operation stop state of stopping the clock input to the processor 101 and stopping the clock and power supply to the corresponding cache memory 102, the cache power control circuit 103 monitors the SCOP1 bus signal on the consistency management bus 122a and the SCCOREREADY1 signal. When the cache power control circuit 103 detects, on the consistency management bus 122a, that a consistency command has been issued from the consistency management circuit 120 (T80), the cache power control circuit 103 switches the power supply control signal PSW12 to the H level, which resumes power supply to the cache memory 102 (T81).

After a lapse of a predetermined time for stabilizing the power supply voltage to the cache memory 102, the cache power control circuit 103 resumes the supply of the clock signal CLK1 (CACHE) to the cache memory 102 (T82). In this state, the cache memory 102 is ready for operation. Then, the cache memory 102 outputs and informs the SCCOREREADY1 signal of the L level indicating “ready for operation” to the consistency management circuit 120. In response to the SCCOREREADY1 signal of the L level, the consistency management circuit 120 transmits data necessary for processing to the cache memory 102 via the consistency management bus 122a. Then, the cache memory 102 performs requested processing (T83-T84).

After the completion of the update of the cache line corresponding to the consistency command, the cache memory 102 returns the SCCOREREADY1 signal to the H level (T85). In response to this, the cache power control circuit 103 stops the supply of the clock signal CLK1 (CACHE) to the cache memory 102. Then, the cache power control circuit 103 returns the power supply control signal PSW12 to the L level, which stops power supply to part of the cache memory 102 (T86).

With the above operation, it is possible to reduce the power consumption of the cache memory 102 except during the operation of control for maintaining the consistency of the caches and also update the cache line in accordance with the consistency command. Further, there are cases where after the cache power control circuit 103 stops clock supply to the cache memory 102, the consistency management circuit 120 issues the consistency command before the cache power control circuit 103 stops power supply to the cache memory 102. In this case, the cache power control circuit 103 may resume clock supply to the cache memory 102 without stopping power supply to the cache memory 102.

Next, an operation for canceling the power saving state of the cache memory 102 will be described. If the processor 101 returns from the operation stop state to the normal state of performing processing, the external signal INT1 of the mode set register 105 is externally controlled, and the mode signal CORE_OFF1 is set to the L level. When the mode signal CORE_OFF1 is set to the L level, the cache power control circuit 103 sets the power supply control signal PSW12 to the H level to resume power supply to the cache memory 102, and then resumes the supply of the clock signal CLK1 (CACHE) to the cache memory 102, thus canceling the power saving state of the cache memory 102.

As described above, according to this embodiment, the transition of the processor to the operation stop state stops clock supply and power supply to the cache memory. This can reduce the power consumption of the cache memory. Further, when the operation for maintaining the consistency of cache data occurs during the time over which clock supply and power supply to the cache memory are stopped, power supply to the cache memory is resumed. This makes it possible to maintain the consistency of cache data.

### Second Embodiment

In the first embodiment, even when the cache memory 102 is in the power saving state, it is necessary to continue power supply to the volatile storage element 132 to retain stored data. This causes the leakage current of the volatile storage element 132.

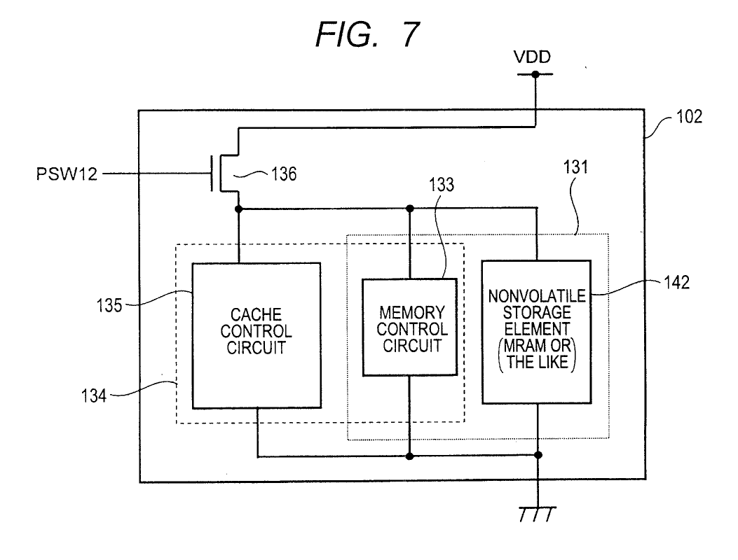

For this reason, in this embodiment, a nonvolatile storage element 142 is used in place of the volatile storage element 132 as shown in FIG. 7, thus stopping power supply to the whole of the cache memory 102 in the power saving state. For example, MRAM (Magnetoresistive Random Access Memory) can be used as the nonvolatile storage element 142. Conventionally, the nonvolatile storage element 142 has a longer access time than the volatile storage element 132, which adversely affects system performance. However, MRAM that has recently been put to practical use has approximately the same access time as SRAM, and is suitably applicable to the present invention.

The configuration of this embodiment is the same as that of the first embodiment, except that power supply to the nonvolatile storage element 142 in the cache memory 102 is stopped in the power saving state. According to this embodiment, it is possible to further reduce the power consumption of the cache memory 102 except during the operation of updating the cache line and also maintain the consistency of cache data.

The present invention is not limited to the above embodiments, but maybe modified and changed without departing from the spirit and scope of the invention. For example, in the above embodiments, both the clock signal and the power supply undergo on-off control for the power saving of the cache memory; however, only the clock signal may undergo on-off control. Further, in the above-described embodiments, only the clock signal is stopped for the power saving of the processor; however, power on-off control may be performed on the processor as well as the clock signal. Moreover, in the above embodiments, the multiple cache power control circuits are provided for the respective cache memories, but may be integrated into one cache power control circuit. Further, in the above-described embodiments, the cache lines have the configuration example of fully associative mapping and a data size of 32 bytes, but may have any other configuration.

What is claimed is:

1. A multiprocessor system comprising:
a first processor having a first cache memory;
a second processor having a second cache memory;
a consistency management circuit coupled to the first and the second cache memories to manage consistency of data stored in the first and the second cache memories; and
a cache power control circuit configured to control power supply to the first or the second cache memory in response to a control signal output from the consistency management circuit.

2. The multiprocessor system according to claim 1,
wherein the cache power control circuit stops power supply to at least a portion of the first cache memory when the first processor transitions to an operation stop state.

3. The multiprocessor system according to claim 2,
wherein the consistency management circuit asserts the control signal to the first cache memory when the consistency management circuit updates data on the first cache memory, and
wherein the cache power control circuit restarts the power supply in response to an assertion of the control signal to the first cache memory after the power supply is stopped.

4. The multiprocessor system according to claim 3,
wherein the cache power control circuit stops the restarted power supply in response to an information signal output from the first cache memory, the information signal indicating a completion of the update data on the first cache memory according to the control signal.

5. A multiprocessor system comprising:
first and second processors;
a shared memory shared by the first and second processors;
first and second cache memories provided respectively corresponding to the first and second processors;
a consistency management circuit for managing consistency of data stored in the first and second cache memories;
a request signal line for transmitting a request signal for a data update request from the consistency management circuit to the first or the second cache memory;
an information signal line for transmitting an information signal for informing completion of the data update from the first or the second cache memory to the consistency management circuit; and
a cache power control circuit for controlling supply of a clock signal and power to the first or the second cache memory in accordance with the request signal and the information signal.

6. The multiprocessor system according to claim 5, wherein when the first processor transitions to an operation stop state, the cache power control circuit stops at least part of power supply to the first cache memory.

7. The multiprocessor system according to claim 6, wherein when the first processor transitions to the operation stop state, the cache power control circuit stops supply of the clock signal to the first cache memory, and then stops at least part of the power supply.

8. The multiprocessor system according to claim 6, wherein after the cache power control circuit stops at least part of the power supply to the first cache memory, the cache power control circuit resumes power supply to the first cache memory when there arises a need for data update to the first cache memory.

9. The multiprocessor system according to claim 8, wherein after completion of the data update, the cache power control circuit again stops power supply to the first cache memory.

10. The multiprocessor system according to claim 5, wherein the first and second cache memories each include:
a volatile storage element;
a cache memory control circuit for controlling the volatile storage element; and
a power supply switch for controlling power supply to the cache memory control circuit.

11. The multiprocessor system according to claim 5, wherein the first and second cache memories each include:
a nonvolatile storage element,
a cache memory control circuit for controlling the nonvolatile storage element, and
a power supply switch for controlling power supply to the nonvolatile storage element and the cache memory control circuit.

12. The multiprocessor system according to claim 11, wherein the nonvolatile storage element is comprised of MRAM.
